(19) United States
(12) Patent Application Publication
(10) Pub. No.: US 2026/0113697 A1
(43) Pub. Date: Apr. 23, 2026

(54) ACCESSBILITY MANAGEMENT OF A USER EQUIPMENT TO A HOME NETWORK

(71) Applicant: T-MOBILE INNOVATIONS LLC, Overland Park, KS (US)

(72) Inventor: Ariful Islam KAZI, Renton, WA (US)

(21) Appl. No.: 18/924,527

(22) Filed: Oct. 23, 2024

(51) Int. Cl. H04W 48/18; H04W 48/16; H04W 84/04

(52) U.S. Cl. CPC H04W 48/18; H04W 48/16; H04W 84/042

(57) ABSTRACT

Embodiments of the present disclosure are directed to systems and methods for managing network accessibility of a user equipment (UE) in a communications network. For example, a user equipment (UE) and information associated with the UE such as device information and subscriber information may be analyzed to determine how the UE should be handled (e.g., during a network acquisition). Based on the device information and subscriber information, one or more roaming attributes of the UE may be modified in order to appropriately manage the accessibility of the UE to one or more communications networks.

### SUMMARY

The present disclosure is directed, in part, to managing network accessibility of a user equipment (UE) to a roaming network in a communications network, substantially as shown and/or described in connection with at least one of the figures, and as set forth more completely in the claims.

According to various aspects of the technology, a communications network may consist of a UE, a Home Public Land Mobile Network (HPLMN), and one or more roaming PLMNs that the UE can connect to when it is outside the coverage area of its home network. The HPLMN may serve as the UE’s primary network, handling subscription-related services, billing, authentication, and network access. When the UE travels outside the coverage area of the HPLMN, it may connect to a roaming PLMN, which may allow the UE to continue accessing services such as voice, data, SMS, and emergency calls.

In a scenario where one communications company is acquired or merged with another, the purchasing company may seek to migrate users from the acquired company’s network to its own network. This may involve changing the HPLMN of the affected users so that their devices now register with and operate under the acquiring company’s core network infrastructure. The migration may involve updating the International Mobile Subscriber Identity (IMSI) on the user’s SIM cards to reflect the Mobile Country Code (MCC) and/or Mobile Network Code (MNC) of the purchasing company’s network. This change may allow the user’s UE to authenticate and receive services from the new HPLMN.

However, the acquiring company may choose to selectively migrate only a subset of users, for example, those with UE that are compatible with the purchasing company’s network infrastructure. Compatibility considerations might include support for specific technologies such as 4G LTE, 5G, or VoLTE, as well as compliance with local regulatory requirements (e.g., emergency call handling). To assess this, the purchasing company may evaluate users’ devices by analyzing their International Mobile Equipment Identity and Software Version (IMEISV) and determining whether the devices support the required network technologies. For example, if the acquiring company’s network operates exclusively on 4G or 5G, it may choose to migrate only users with devices that support these technologies, while maintaining users with incompatible devices on the legacy network. The migration process may involve over-the-air (OTA) updates to user SIM cards, which may allow the transition to occur seamlessly without the need for physical SIM replacements.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

FIG. 1 illustrates an exemplary computing device for use with the present disclosure;

FIG. 2 illustrates a diagram of an exemplary network environment in which implementations of the present disclosure may be employed;

FIG. 3 illustrates an example flow diagram in which implementations of the present disclosure may be employed; and

FIG. 4 illustrates a flow chart of an exemplary method for managing network accessibility of a user equipment (UE) in a communications network in which implementations of the present disclosure may be employed.

### DETAILED DESCRIPTION

By way of background, when a HPLMN services a UE, it may provide the UE with direct access to the range of services supported by the subscriber’s home network. The HPLMN may manage the UE’s authentication, mobility, and service entitlements through its core network components, such as the Home Subscriber Server (HSS) and the Policy and Charging Rules Function (PCRF). When the UE is within the coverage area of the HPLMN, it may register directly with the network, and the core network may process tasks such as call routing, data sessions, and SMS delivery. The HPLMN may also enforce subscriber-specific policies, such as quality of services (QoS) levels and data allowances, to help ensure that the UE receives the services it is entitled to based on the user’s subscription plan. In contrast, when a roaming PLMN (e.g., VPLMN) services the UE, the roaming PLMN may provide the radio access infrastructure that allows the UE to connect to the roaming PLMN while it is outside its HPLMN’s coverage area. The roaming PLMN may handle the initial registration and provide access to voice, data, and messaging services using its local infrastructure. However, the core subscriber services (e.g., authentication, billing, and service entitlements) are still managed by the HPLMN. The roaming PLMN may communicate with the HPLMN using roaming agreements to authenticate the UE and help ensure that the services provided by the roaming PLMN are in line with the user’s subscription profile.

When a network operator undergoes a merger, acquisition, or significant infrastructure upgrade, the migration of UEs from one network to a new network infrastructure presents several challenges. For example, one of the challenges may include device compatibility with a network. If the new network operates primarily on newer technologies (e.g., 4G LTE, 5G, or 6G), UEs that only support older technologies (e.g., 2G or 3G) may not be able to connect or use certain services. Another challenge may arise when updating HPLMN information (e.g., IMSI) associated with the UEs. The IMSI, which includes the MCC and MNC, may identify the subscriber’s home network. When migrating to a new network, this IMSI information may need to be updated to reflect the new network’s MCC and MNC. Without proper updates, the UE may face difficulties in registering with the new network, leading to service interruptions. Additionally, roaming agreements present a challenge during the migration process. The acquiring or new network might have different roaming agreements with visited networks compared to the previous operator. This may create a situation where UEs may not be able to roam or may connect to unintended networks, leading to service disruptions, unexpected charges, or limited service availability.

To address the challenges of migrating UEs to a new network infrastructure, the present systems and methods provide solutions involving a network device, which could include a controller, to help manage the process. This controller, which could be integrated with or separate from the HSS, may receive indications to initiate a migration process based on one or more triggers. These indications could include a device registration attempt when the UE tries to access the network, a network registration event indicating that the UE is attempting to connect to a specific PLMN, and/or a periodic sweep where the controller reviews a plurality of UEs to determine which devices should be migrated based on pre-defined schedules or network expansion initiatives. Upon receiving the indication the controller may begin the migration logic flow by retrieving device information from the EIR, including the IMEISV, which may provide details about the UE’s hardware and software capabilities. Additionally, the controller may retrieve subscriber information from the HSS or during the UE’s registration process, such as the IMSI, which may include the MCC and MNC. These identifiers may be helpful in determining how to modify one or more roaming attributes of the UE.

Once the device and subscriber information is gathered, the controller may assess whether the UE is compatible with the new network infrastructure. If the device information reveals that the UE is compatible (e.g., the UE supports the necessary network technologies), the controller may proceed to modify the one or more roaming attributes of the UE. For example, the modification may include updating the IMSI to reflect the MCC and MNC of the new network. Such a modification may essentially change the UE’s HPLMN, so that the UE now registers with the acquiring company’s core network as its home network. In some aspects, the controller may convert the HPLMN of the UE to a roaming PLMN. This may happen when the operator desires to maintain connectivity for a transition period while moving users from one infrastructure to another. By converting the old HPLMN to a roaming PLMN, the controller may help ensure that the UE is still able to access services, but as a roaming device rather than a home subscriber, which may allow the operator to phase out the old network while steering users toward the new infrastructure.

For UEs that are incompatible with the new network (e.g., those that only support legacy technologies), the controller may take alternative actions. In such aspects, the controller may modify the roaming attributes by placing the old HPLMN on an unauthorized roaming list, which may prevent the UE from continuing to connect to the old network. This may help ensure that incompatible devices are separated from the legacy infrastructure and prevent unnecessary strain on resources. The controller may then flag these devices for further action, such as notifying users that an upgrade is necessary or restricting their access to basic services until they transition to a compatible devices. Additionally, the controller may modify the UE’s preferred roaming list or Roaming Steering Information (RSI) to help ensure that when the UE is outside the coverage of its new HPLMN, it connects to authorized roaming networks that have the required technical compatibility. This could include directing the UE towards specific roaming PLMNs that support legacy services for a limited time, allowing users to migrate gradually.

In one non-limiting example scenario, Telecom A acquires Telecom B. Telecom A plans to migrate users from Telecom B’s network to its own infrastructure. Telecom A has a controller integrated with its HSS to manage the migration process. The controller receives periodic triggers to initiate migration checks, such as when a UE from Telecom B attempts to register on the network or during a scheduled sweep of devices in Telecom B’s subscriber base. The controller may begin by retrieving the IMEISV from the EIR to gather information about the UE’s hardware and software capabilities. The controller may also pull the IMSI from the HSS to identify the current HPLMN of the UE, which belongs to Telecom B. In some aspects, the controller may analyze the device information and determine that the UE is compatible with Telecom A’s network. Accordingly, the controller modifies the IMSI by updating the MCC and MCN to reflect Telecom A’s HPLMN. The controller might also update roaming attributes of the UE to convert Telecom B’s old HPLMN to a roaming PLMN. In some aspects, the UE may be determined to be incompatible with Telecom B’s network and a different action is taken. For example, the controller may modify the roaming attributes of the UE to place Telecom B’ old HPLMN on an unauthorized list, preventing the UE from continuing to connect to the outdated infrastructure. This may include updating the RSI associated with the UE to steer the UE towards roaming PLMNs that still support legacy services.

Accordingly, a first aspect of the present disclosure is directed to a system for managing network accessibility of a user equipment (UE) in a communications network. The system includes a network device comprising one or more processors. The system further includes a non-transitory computer-readable media configured to receive, at the network device, an indication to initiate a logic flow. The computer-readable media is further configured to retrieve, by the network device during the logic flow, device information associated with the UE and subscriber information associated with the UE. The computer-readable media is further configured to, based on the device information and the subscriber information, modify one or more roaming attributes of the UE.

A second aspect of the present disclosure is directed to a non-transitory computer-readable media that, when executed, cause a user equipment comprising one or more processors to perform operations for managing network accessibility of a user equipment (UE) in a communications network. For example, the computer-readable media is configured to receive, at the network device, an indication to initiate a logic flow. The computer-readable media is further configured to retrieve, by the network device during the logic flow, device information associated with the UE and subscriber information associated with the UE. The computer-readable media is further configured to, based on the device information and the subscriber information, modify one or more roaming attributes of the UE.

A third aspect of the present disclosure is directed to a method for managing network accessibility of a user equipment (UE) in a communications network. The method includes receiving an indication to initiate a logic flow. The method further includes retrieving device information associated with the UE and subscriber information associated with the UE. The method further includes, based on the device information and the subscriber information, modify one or more roaming attributes of the UE.

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022).

The example aspects and embodiments described in the present disclosure are provided within the context of a wireless telecommunication network for illustrative purposes. However, it should be understood that the principles and techniques discussed herein are not limited to wireless networks alone. The concepts and methodologies can be equally applied to other types of communication networks, including but not limited to wired, satellite, and optical networks. These alternative networks are capable of supporting the functionalities and applications described, and their use falls within the scope of the present disclosure.

As used herein, a “Home Public Land Mobile Network (HPLMN)” may refer to a primary mobile network with which a UE is registered and has a subscription. The HPLMN may be identified by the IMSI stored in the UE’s SIM card, which may include the MCC and MNC that uniquely identifies the home network operator and country. The HPLMN may be responsible for managing the subscriber’s authentication, billing, and service entitlements. When the UE is within the coverage area of the HPLMN, it may connect directly to the core network for services such as voice, data, and SMS.

As used herein, a “roaming Public Land Mobile Network (PLMN),” also referred to as a visiting PLMN (VPLMN), may refer to any foreign network that the UE connects to when it is outside the coverage area of its HPLMN. For example, the UE may use the infrastructure (e.g., core network) of the roaming PLMN to access services, while the HPLMN may continue to manage subscriber authentication and billing through roaming agreements. The VPLMN may help enable the UE to maintain connectivity to services such as voice, data, and SMS while traveling.

As used herein, a “roaming attribute” of a UE may refer to a piece of information or setting within a communications network that determines how the UE behaves when it is outside its HPLMN. Roaming attributes may be helpful for managing the UE’s roaming capabilities, access services, and compliance with network and regulatory requirements while the UE is connected to foreign networks. For example, roaming attributes may comprise an IMSI, allowed roaming networks (e.g., a list of PLMNs the UE is permitted to connect to based on roaming agreements between the home network and the visited networks), roaming permissions and restrictions (e.g., rules that define whether the UE is allowed to roam domestically or internationally and what services are available when roaming), service entitlements, preferred roaming networks, and Roaming Steering Information (RSI).

As used herein, a “Home Subscriber Service (HSS)” may refer to a database that helps manage and store subscriber information. The HSS may be responsible for authenticating users, managing their profiles, and enabling access to services within the network. The HSS may store “subscriber information” such as the IMSI, which uniquely identifies the user’s subscription and links them to their HPLMN. In addition to the IMSI, the HSS may hold other information, including Mobile Station International Subscriber Directory Number (MSISDN) and authentication credentials used for secure communications between the UE and the network.

As used herein, a “Unified Network Directory Server (UNDS)” may refer to a centralized repository that helps with managing network preferences, subscriber policies, and/or roaming-related data. For example, the UNDS may maintain the “RSI,” which may refer to a set of data and policies used to steer a UE to suitable roaming networks when subscribers travel outside their home network’s coverage area. The RSI stored in the UNDS may contain various types of information such as preferred roaming networks (e.g., a list of partner networks that the home operator prioritizes based on agreements, cost efficiency, or quality of service (QoS)) and subscriber-specific preferences (e.g., information tailored to different groups of users, such as business or premium customers, that might influence which networks they are directed to).

As used herein, an “Equipment Identity Register (EIR)” may refer to a component in a communications network that helps manage and verify the identities of UEs based on their IMEISV numbers. For example, the EIR may act as a database that categorizes UEs into three lists: white list, black list, and gray list. UEs on the white list may be authorized to access the network, while black-listed devices (e.g., typically stolen, lost, or fraudulent devices) may be barred from accessing network services. Devices on the gray list may be allowed to access the network but may have restricted functionality. For example, when a UE attempts to register on the network, the EIR may cross-reference the UE’s IMEISV to determine its status and decide whether it should be granted access. An EIR may store “device information,” which may refer to a set of unique identifiers, attributes, and/or status details associated with a UE. Device information may include the UE’s IMEISV, which includes details about the device’s current software version. Other device information stored in the EIR may include hardware specifications, device model (e.g., Type Allocation Code (TAC)), network technology capabilities, and/or compliance status with security and regulatory standards. Such device information may help operators manage device access, security, and service eligibility across their network.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions – including data structures and program modules – in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

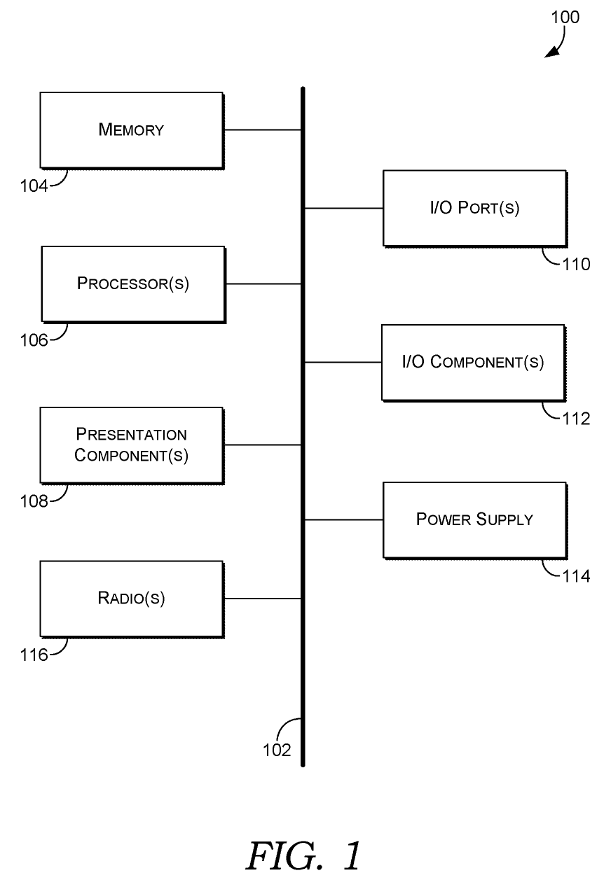

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment (UE), wireless communication device, or user device, The computing device 100 may take many forms; non-limiting examples of the computing device 100 include a fixed wireless access device, cell phone, tablet, internet of things (IoT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

The radio 120 represents one or more radios that facilitate communication with one or more wireless networks using one or more wireless links. While a single radio 120 is shown in FIG. 1, it is expressly contemplated that there may be more than one radio 120 coupled to the bus 102. In aspects, the radio 120 utilizes a transmitted to communicate with a wireless telecommunications network. It is expressly contemplated that a computing device 100 with more than one radio 120 could facilitate communication with the wireless network via both the first transmitter and additional transmitters (e.g. a second transmitter). Illustrative wireless telecommunications technologies include CDMA, GPRS, TDMA, GSM, and the like. The radio 120 may carry wireless communication functions or operations using any number of desirable wireless communication protocols, including 802.11 (Wi-Fi), WiMAX, LTE, 3G, 4G, LTE, 5G, NR, VoLTE, or other VoIP communications. As can be appreciated, in various embodiments, radio 120 can be configured to support multiple technologies and/or multiple radios can be utilized to support multiple technologies. A wireless telecommunications network might include an array of devices, which are not shown as to obscure more relevant aspects of the invention. Components such as a base station or communications tower (as well as other components) can provide wireless connectivity in some embodiments.

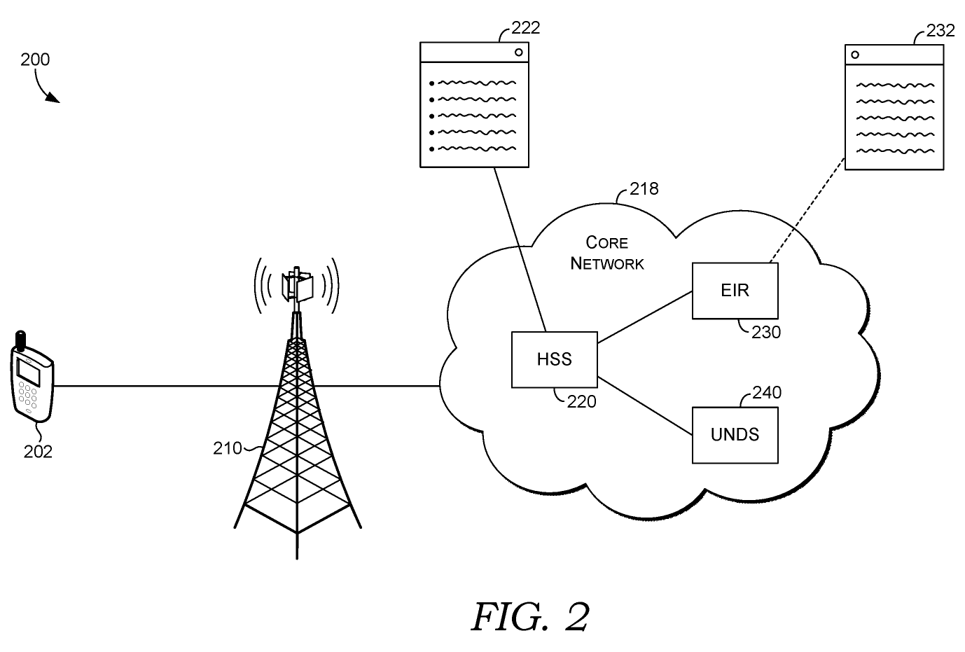

Referring now to FIG. 2, an exemplary network environment is illustrated in which implementations of the present disclosure may be employed. Such a network environment is illustrated and designated generally as network environment 200. Network environment 200 is but one example of a suitable network environment and is not intended to suggest any limitation as to the scope of use or functionality of the invention. Neither should the network environment be interpreted as having any dependency or requirement relating to any one or combination of components illustrated.

Network environment 200 represents a high level and simplified view of relevant portions of a modern wireless telecommunication network. At a high level, the network environment 200 may generally be said to comprise one or more UEs, such as UE 202, one or more base stations, such as a base station 210, a core network 218, an HSS 220 that stores subscriber information 222 of one or more UEs, an EIR 230 that stores device information 232 of one or more UEs, and a UNDS 240 that stores RSI of one or more UEs, though in some implementations, it may not be necessary for certain features to be present. The network environment may include a number of routers, switches, and the like. The network environment 200 is generally configured for wirelessly connecting the UE 202 to data or services that may be accessible through the core network 218 or other functions, nodes, or servers not pictured in FIG. 2 so as to not obscure the focus on the present disclosure.

The UE 202 is illustrated generally, and may take any number of forms, including a tablet, phone, or wearable device, or any other device discussed with respect to FIG. 1 and may have any one or more components or features of the computing device 100 of FIG. 1. In some aspects, the UE 202 may not be a conventional telecommunications devices (i.e., a device that is capable of placing and receiving voice calls), but may instead take the form of devices that only utilizes wireless network resources in order to transmit or receive data; such devices may include IoT devices (e.g., smart appliances, thermostats, locks, smart speakers, lighting devices, smart receptacles, and the like).

The base station 210 may provide a network access location where the UE may potentially connect to (also referred to as ‘camping on,’ ‘attaching,’ in the industry). Though network environment 200 is illustrated with only the base station 210, one skilled in the art will appreciate that more or fewer base stations may be present in any particular network environment. The first base station 210 is configured to wirelessly communicate with UEs, such as the UE 202. In aspects, the base station 210 may communicate with the UE 202 using any wireless telecommunication protocol desired by a network operator, including but not limited to 3G, 4G, 5G, 6G, 802.11x and the like.

The core network 218 may provide services and connectivity to the UE 202. For example, the core network 218 may manage the routing, authentication, and delivery of voice, data, and messaging services to the UE 202, regardless of whether the UE is operating within its home network or on a roaming network (e.g., a roaming PLMN). The core network 218 may be responsible for handling key functions such as subscriber authentication, enforcing policies, and managing device access through the EIR 230. In some aspects, the core network 218 may include packet gateways and session management functions that help control the UE’s 202 access to external data networks and multimedia services. For example, the core network 218 may communicate with the base station 210 to provide services to the UE 202. When the UE 202 roams, the core network 218 may help coordinate with roaming partners and manage the exchange of network preferences (e.g., RSI), device information (e.g., device information 232), and subscriber information (e.g., subscriber information 222) through systems like the HSS 220, the EIR 230, and the UNDS 240.

The UE 202 may be associated with a HPLMN, which may be the primary network where the UE 202 has its subscription. In some aspects, when the UE 202 is powered on or moves back into its home coverage area, it may initiate a network search to identify and attach to its HPLMN. The core network 218, particularly the HSS 220 and the EIR 230, may play a role in facilitating this process. For example, the UE 202 may use the IMSI stored in its SIM card to identify its MCC and MNC, which may correspond to its HPLMN. The UE 202 may scan for available networks and compares the MCC and MNC of each detected network with the IMSI to identify its home network. Once the UE 202 identifies its HPLMN, it may send a registration request to the network.

When the UE 202 moves outside the coverage area of its HPLMN, it may need to attach to a roaming PLMN (e.g., a VPLMN). For example, the UE 202 may begin by scanning the available networks in its current location. The roaming networks identified during this scan may be evaluated against the UE’s 202 Preferred Roaming List or RSI, which may be maintained by the HSS or in conjunction with the Roaming Steering Server (RSS). Based on roaming agreements, the UE 202 may prioritize the PLMNs it can connect to. Once a potential roaming PLMN is selected, the UE 202 may send a registration request to that network, which then communicates with the UE’s 202 HPLMN for authentication and authorization. The HSS 220 may be contacted by the roaming PLMN to verify the UE’ IMSI and to retrieve the subscriber’s service profile, which may include information on which services the subscriber is entitled to use while roaming. The UE’s 202 device information 232 stored in the EIR 230 may also be checked to confirm the device is not blacklisted and is allowed to connect to the roaming PLMN. Once the HSS 220 confirms the subscriber’s identity and service entitlements, the HSS 220 may generate authentication vectors that are sent to the roaming PLMN to securely authenticate the UE 202, which the roaming PLMN uses to grant access to the UE 202.

In the context of managing network access and/or migration between one or more networks, the HSS 220, or a controller integrated with or separate from the HSS 220, may receive various indications that trigger it to initiate a logic flow aimed at determining how to handle the UE 202. These indications may serve as signals to start a process that may involve evaluating the UE’s 202 eligibility for network attachment, migration, and/or modification of one or more roaming attributes associated with the UE 202. In some aspects, the indication may comprise a registration request of the UE 202. For example, when the UE 202 attempts to connect to a network (e.g., either the HPLMN or a roaming PLMN), it sends a registration request to the network. This event may prompt the HSS 220 to authenticate the subscriber, retrieve the UE’s 202 service profile, and initiate a logic flow to evaluate whether the UE should be allowed to connect, and whether any roaming attributes need to be modified. In some aspects, the indication may comprise periodic sweeps initiated by the network operator to assess the status of the UE 202. These sweeps might include checking the compatibility of the UE 202 with new infrastructure, for example, after a network upgrade or acquisition. In some aspects, the indication may be related to network policy updates or roaming agreement changes. For example, if the operator updates its roaming agreements with foreign networks or changes the preferred roaming partners, the HSS 220 or controller might be triggered to re-evaluate the RSI or update one or more roaming attributes of the UE 202 to reflect these new policies.

In response to the indication received by the HSS 220, the HSS 220 (or the controller), may retrieve the subscriber information 222 and/or the device information 232 associated with the UE 202. For example, the subscriber information 222 may be retrieved from the HSS 220, which may include a detailed profile for the subscriber associated with the UE 202. The subscriber information 222 may include the IMSI, which uniquely identifies the UE’s 202 subscription and links it to the HPLMN. Along with the subscriber information 222, the HSS 220 may also retrieve the subscriber service profile associated with the UE 202, which may contain information about service entitlements and any relevant restrictions (e.g., roaming restrictions). The HSS 220 (or the controller) may also retrieve the device information 232 (e.g., IMEISV) from the EIR 230, which provides information about the UE’s 202 hardware, including the device model, capabilities, and current software version. This information may allow the HSS 220 to determine whether the UE 202 is running up-to-date software. The combination of the subscriber information 222 from the HSS 220 and the device information 232 from the EIR 230 may help provide the HSS 220 with a view of both the subscription details of the user associated with the UE 202 along with the UE’s 202 technical capabilities.

Once the HSS 220, or the controller integrated with or separate from the HSS 220, retrieves and analyzes the subscriber information 222 and the device information 232, it may proceed to modify one or more roaming attributes of the UE 202 based on this analysis. The one or more roaming attributes may include data that governs how the UE 202 behaves when connecting foreign networks (e.g., roaming PLMNs) or even its home network (e.g., HPLMN). Depending on the result of this analysis and the operator’s goals, several types of modifications can be made to the one or more roaming attributes associated with the UE 202. For example, in some aspects, if the analysis reveals that the UE 202 is compatible with the new network infrastructure (e.g., supporting the required technologies), the HSS 220 may update the MCC and MNC within the IMSI. This modification may effectively change the HPLMN of the UE 202, reassigning it to an acquiring or updated network. As a result, the UE 202 will now connect and register with the new HPLMN rather than its old HPLMN, helping to ensure the subscriber and the associated UE 202 are migrated to the new infrastructure. In some aspects, the HSS 220 may convert the existing HPLMN into a roaming PLMN. This process might be helpful during a transitional period, where the operator wishes to maintain the UE’s 202 connectivity but treat its original home network as a visited or roaming network. By modifying the roaming attributes to prioritize a different network as the HPLMN, the UE 202 can continue to function while the legacy network is phased out. Such an approach may help provide a smooth migration while still providing services through the original network infrastructure, which may now be treated as a roaming PLMN (e.g., by converting a HPLMN of the UE 202 to a roaming PLMN).

In some aspects, where the UE 202 may be found to be incompatible with the new network, such as those that only support outdated technologies, the HSS 220 may modify the one or more roaming attributes associated with the UE 202 by adding the HPLMN of the UE 202 to an unauthorized roaming list. This action may effectively prevent the UE 202 from registering on the legacy network by helping to ensure that incompatible devices do not continue to access the old infrastructure. By denying access to the UE 202 from the original HPLM, the network operator may help ensure that the UE 202 is either upgraded or disconnected from the outdated infrastructure, thereby optimizing network resources. In some aspects, the HSS 220 may update the RSI associated with the UE 202 to direct the UE 202 toward preferred roaming networks when outside the coverage area of the new HPLMN. For example, if roaming agreements have changed due to the network consolidation or updates, the RSI can be modified to prioritize connections with specific roaming PLMNs that are compatible with the UE’s 202 technical capabilities and the new network’s strategic partnerships. The various modifications of the one or more roaming attributes of the UE 202 may help ensure that the UE’s 202 roaming behavior aligns with the updated network infrastructure and policy requirements, providing seamless connectivity, while also phasing out access to legacy or incompatible networks. The HSS’s 220, or the controller’s, ability to dynamically adjust roaming attributes, such as the MCC/MNC within the IMSI, the treatment of HPLMNs as roaming PLMNs, or the RSI, helps ensure that the migration process or network changes are handled smoothly and efficiently.

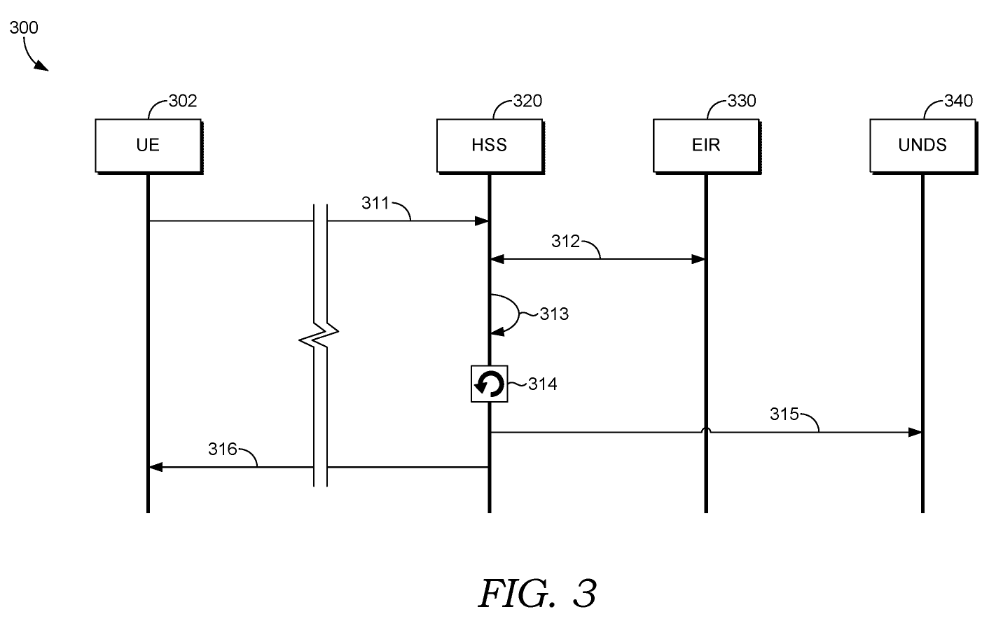

Turning now to FIG. 3, a flow diagram is illustrated in accordance with one or more aspects of the present disclosure. A flow diagram 300 may be said to exist between one or more components discussed in greater detail herein and is not meant to exhaustively show every interaction that would be necessary to practice the invention, so as not to obscure the present disclosure, but is instead meant to illustrate one or more potential interactions between components. The flow diagram 300 may be relevantly said to include a UE 302, an HSS 320, an EIR 330, and a UNDS 340. In some aspects, the UE 302 may be the same or similar to the UE 202, the HSS 320 may be the same or similar to the HSS 220, the EIR 330 may be the same or similar to the EIR 230, and the UNDS 340 may be the same or similar to the UNDS 240 discussed above.

FIG. 3 illustrates an example method for managing network accessibility of a user equipment (UE) in a communications network. At a first step 311, the HSS 320 (or the controller) may receive an indication to initiate a logic flow aimed at determining whether, and how, to modify one or more roaming attributes of the UE 302. The indication may include a device registration attempt of the UE 302. For example, when the UE 302 attempts to connect to a network, either the HPLMN or a roaming PLMN, it sends a registration request to the network. The indication may also include a network registration, such as when the UE 302 is attempting to a new or updated network, especially after a merger or acquisition. The indication may also comprise a periodic sweep or network audit (e.g., scheduled processes where the system reviews the UE’s 302 compatibility with network infrastructure). The indication may also comprise a change in network policy or roaming agreements or a device-specific event (e.g., when the EIR 330 flags the UE 302 as being on a gray list).

At a second step 312, after receiving the indication to initiate the logic flow, the HSS 320 may proceed to retrieve device information (e.g., device information 232) of the UE 302 from the EIR 330, where the EIR 330 may comprise a centralized database within the core network that stores details about the identity and status of UEs, particularly using the IMEISV. For example, the HSS 320 may send a query to the EIR 330 using the UE’s 302 IMEI as an identifier. The query may specifically request the device information, including the IMEISV, which provides both the device’s identity and its current software version. Upon receiving the query, the EIR 330 may search its database for the matching IMEI/IMEISV. The EIR 330 may retrieve additional device information such as hardware model, supported network technologies, and/or compliance status. The EIR 330 may send the request device information back to the HSS 320, which may include one or more of the IMEISV, device classification (e.g., white, black, or gray list), and any associated restrictions or warnings related to the device status of the UE 302.

At a third step 313, the HSS 320 may retrieve subscriber information (e.g., subscriber information 222) associated with the UE 302. For example, the HSS 320 (or the controller) may access the subscriber profile based on the IMSI associated with the UE 302. If the HSS 320 is not already in possession of the IMSI, the HSS 320 may retrieve the IMSI from the UE’s 302 SIM card. The subscriber information may include the IMSI, service entitlements, roaming permissions, and/or a subscriber status associated with the UE 302.

At a fourth step 314, the HSS 320 may make a determination about whether to modify one or more roaming attributes of the UE 302 in order to help ensure that the UE 302 is properly configured to connect to the appropriate networks, for example, as a part of a migration to a new network infrastructure or in response to updated roaming policies or network capabilities. For example, the HSS 320 may evaluate the device information (e.g., the IMEISV), to determine the UE’s 302 compatibility with existing or new network infrastructure. If the UE 302 is running outdated software, or if it is incapable of supporting required network features, the HSS 320 may flag this as a potential issue. The HSS 320 (or the controller) may check whether the UE 302 can support the services offered by the home network or the visited network it is trying to connect to. The HSS 320 may also examine the subscriber profile, which includes roaming permissions and service entitlements. In cases where roaming agreements or policies have changed (e.g., after a network merger or infrastructure upgrade), the HSS 320 may determine whether updates are needed to align the UE’s 302 roaming attributes with the current network policies. This may include assessing whether the UE 302 should continue to connect to the old home network or be migrated to a new one. In some aspects, based on the analysis of both device compatibility and roaming permissions, the HSS 320 may make a determination to either modify the UE’s 302 roaming attributes or leave them unchanged. For UEs that are fully compatible with the current network infrastructure and meet all roaming requirements, no changes may be necessary. However, for UEs that are incompatible, running outdated software, or subject to a network migration, the HSS 320 may initiate modification to the UE’s 302 roaming attributes. For example, if the determination is made to migrate the UE 302 to a new network infrastructure (e.g., after a network acquisition), the HSS 320 may modify the IMSI by updating the MCC and MNC within the IMSI to effectively change the UE’s 302 HPLMN, causing the UE 302 to now register and treat the new network as its home network. In situations where the UE 302 needs to maintain temporary access to its old HPLMN (e.g., during a network transition period), the HSS 320 may convert the old HPLMN into a roaming PLMN. This modification allows the UE 302 to continue accessing the old network, but as a visited network instead of its home network. Such an approach may be helpful in managing a gradual migration where the UE 302 can still use services from the old network while preparing for the full migration to the new network. For UEs that are incompatible with the new infrastructure (e.g., devices that only support outdated technologies), the HSS 320 may modify the roaming attributes by placing the old HPLMN on an unauthorized list. This modification may restrict the UE 302 from registering with the old network, effectively separating incompatible devices from the legacy infrastructure.

At a fifth step 315, the HSS 320 (or the controller) may update the RSI associated with the UE 302 in the UNDS 340, where the RSI may govern how the UE 302 behaves while roaming, specifying preferred and restricted roaming networks while outside of the HPLMN. For example, the HSS 320 may initiate a request to update the UE’s 302 RSI. In doing so, the HSS 320 may update the preferred roaming networks and any restricted networks. If the HSS 320 determines that the UE 302 should be steered toward a specific set of roaming networks (e.g., based on new roaming agreements or network strategy), it may modify the RSI to reflect this priority (e.g., adding the MCC and MNC of the preferred roaming networks to the RSI and instructing the UE 302 to prioritize those networks when roaming). Additionally, if the HSS 320 determines that the UE’s 302 HPLMN should be converted into a roaming PLMN, the updated RSI will reflect this change. In such a situation, the previous HPLMN may now be treated as a visited network, allowing the UE 302 to still connect to its legacy network, but only in a roaming capacity.

At a sixth step 316, the HSS 320 (or the controller) may help play a role in the authorization/restriction and synchronization of the modified roaming attributes across the communications network. For example, once the RSI modifications have been made in the UNDS 340, the updated roaming attributes may be propagated across various core network elements to help ensure that the UE’s 302 behavior aligns with the new configuration. In some aspects, the HSS 320 may help ensure that the UE 302 is steered toward the new HPLMN for home network connections, while still allowing access to the old HPLMN under roaming conditions. In some aspects, once the authorization/restrictions decisions have been applied, the UE’s 302 configuration is effectively updated to follow the new roaming attributes. This update may occur when the UE 302 re-registers on the network or initiates a new connection, at which point the core network may enforce the updated roaming policies stored in the HSS 320 and the UNDS 340. In some aspects, the UE’s 302 SIM card may also receive OTA updates, particular if changes were made to the IMSI, such as modifications to the MCC and/or MNC.

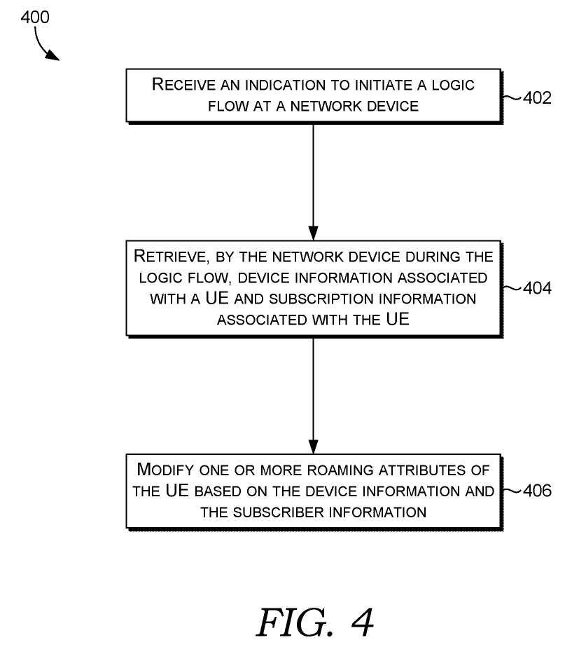

Turning now to FIG. 4, a flow chart is provided that illustrates one or more aspects of the present disclosure relating to a method 400 for managing network accessibility of a user equipment (UE) in a communications network. For example, at a first step 402, an indication is received to initiate a logic flow at a network device. At a second step 404, device information and subscriber information associated with the UE are retrieved by the network device during the logic flow. At a third step 406, one or more roaming attributes of the UE are modified based on the device information and subscriber information.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A system for managing network accessibility of a user equipment (UE) in a communications network, the system comprising:
a network device comprising one or more processors; and a non-transitory computer-readable media comprising executable instructions that, when executed, causes the network device to perform operations in a communication network, comprising: receiving, at the network device, an indication to initiate a logic flow; retrieving, by the network device during the logic flow, device information associated with the UE and subscriber information associated with the UE; and based on the device information and subscriber information, modifying one or more roaming attributes of the UE.

2. The system of claim 1, wherein the network device comprises a Home Subscriber Server (HSS).

3. The system of claim 1, wherein the indication comprises a device and/or network registration of the UE.

4. The system of claim 1, wherein the device information comprises an International Mobile Equipment Identity and Software Version (IMEISV) of the UE.

5. The system of claim 1, wherein the IMEISV is retrieved from an equipment identity register (EIR) in the communications network.

6. The system of claim 1, wherein the subscriber information comprises an International Mobile Subscriber Identity (IMSI) associated with the UE.

7. The system of claim 6, wherein modifying the one or more roaming attributes comprises modifying a Mobile Country Code (MCC) and/or a Mobile Network Code (MNC) within the IMSI.

8. The system of claim 1, wherein modifying the one or more roaming attributes comprises modifying a Home Public Land Mobile Network (HPLMN) of the UE.

9. The system of claim 1, wherein modifying the one or more roaming attributes comprises converting a Home Public Land Mobile Network (HPLMN) of the UE to a roaming PLMN.

10. The system of claim 1, wherein modifying the one or more roaming attributes comprises adding a Home Public Land Mobile Network (HPLMN) of the UE to an unauthorized roaming list.

11. A non-transitory computer-readable media comprising executable instructions that, when executed, causes a user equipment comprising one or more processors to perform operations for managing network accessibility of a user equipment (UE) in a communications network, the executable instructions comprising the steps of: receiving, at the network device, an indication to initiate a logic flow; retrieving, by the network device during the logic flow, device information associated with the UE and subscriber information associated with the UE; and based on the device information and subscriber information, modifying one or more roaming attributes of the UE.

12. The computer-readable media of claim 11, wherein the device information comprises an International Mobile Equipment Identity and Software Version (IMEISV) of the UE.

13. The computer-readable media of claim 11, wherein the subscriber information comprises an International Mobile Subscriber Identity (IMSI) associated with the UE.

14. The computer-readable media of claim 11, wherein the device information comprises an International Mobile Equipment Identity and Software Version (IMEISV) of the UE.

15. The computer-readable media of claim 14, wherein modifying the one or more roaming attributes comprises modifying a Mobile Country Code (MCC) and/or a Mobile Network Code (MNC) within the IMSI.

16. The computer-readable media of claim 11, wherein modifying the one or more roaming attributes comprises converting a Home Public Land Mobile Network (HPLMN) of the UE to a roaming PLMN.

17. A method for managing network accessibility of a user equipment (UE) in a communications network, the method comprising: receiving, at the network device, an indication to initiate a logic flow; retrieving, by the network device during the logic flow, device information associated with the UE and subscriber information associated with the UE; and based on the device information and subscriber information, modifying one or more roaming attributes of the UE.

18. The method of claim 17, wherein the device information comprises an International Mobile Equipment Identity and Software Version (IMEISV) of the UE.

19. The method of claim 18, wherein modifying the one or more roaming attributes comprises modifying a Mobile Country Code (MCC) and/or a Mobile Network Code (MNC) within the IMSI.

20. The method of claim 17, wherein modifying the one or more roaming attributes comprises converting a Home Public Land Mobile Network (HPLMN) of the UE to a roaming PLMN.
